(19) United States
(12) Patent Application Publication
(10) Pub. No.: US 2013/0278360 A1
(43) Pub. Date: Oct. 24, 2013

(54) DIELECTRIC CONDUITS FOR EHF COMMUNICATIONS

(71) Applicant: WaveConnex, Inc., Mountain View, CA (US)

(72) Inventors: Yanghyo Kim, Los Angeles, CA (US); Mau-Chung Frank Chang, Los Angeles, CA (US); Emilio Sovero, Thousand Oaks, CA (US); Gary D. McCormack, Tigard, OR (US); Ian A. Kyles, West Linn, OR (US)

(21) Appl. No.: 13/922,062

(22) Filed: Jun. 19, 2013

Related U.S. Application Data
(63) Continuation-in-part of application No. 13/541,543, filed on Jul. 3, 2012.
Application No. 13/541,543 is a continuation of application No. 13/760,089, filed on Feb. 6, 2013.
Application No. 13/760,089 is a continuation of application No. 13/776,727, filed on Feb. 26, 2013.
Application No. 13/776,727 is a continuation of application No. 13/848,735, filed on Mar. 22, 2013.
(60) Provisional application No. 61/661,756, filed on Jun. 19, 2012.
(60) Provisional application No. 61/504,625, filed on Jul. 5, 2011.
(60) Provisional application No. 61/786,522, filed on Mar. 15, 2013.

(51) Int. Cl. H01P 3/16

(52) U.S. Cl. CPC H01P 3/165
USPC 333/239

(57) ABSTRACT

Dielectric conduits for the propagation of electromagnetic EHF signals include an elongate body of a dielectric material extending continuously along a longitudinal axis between a first terminus and a second terminus. At each point along the longitudinal axis, an orthogonal cross-section of the elongate body has a first dimension along a major axis of the cross-section, where the major axis extends along the largest dimension of the cross-section. The orthogonal cross-section also has a second dimension along a minor axis of the cross-section, where the minor axis extends along a widest dimension of the cross-section that is at a right angle to the major axis. For each cross-section of the elongate body, the first dimension is greater than the wavelength of the electromagnetic EHF signals and the second dimension is less than the wavelength of the electromagnetic EHF signals.

### RELATED PATENTS AND APPLICATIONS

This application claims the benefit under 35 U.S.C. §119(e) of U.S. Provisional Patent Application No. 61/661,756, filed Jun. 19, 2012, and entitled DIELECTRIC COUPLERS FOR EHF COMMUNICATIONS, which application is incorporated herein by reference in its entirety for all purposes.

The present application is a continuation-in-part under 35 U.S.C. §120 of U.S. patent application Ser. No. 13/541,543, filed Jul. 3, 2012, and entitled EHF COMMUNICATION WITH ELECTRICAL ISOLATION AND WITH DIELECTRIC TRANSMISSION MEDIUM; which in turn claims the benefit under 35 U.S.C. §119(e) of U.S. Provisional Patent Application No. 61/504,625, filed Jul. 5, 2011 and entitled ELECTRICAL ISOLATOR USING EHF COUPLING, each of which is incorporated by reference in its entirety.

The present application is also a continuation under 35 U.S.C. §120 of the following: (1) U.S. patent application Ser. No. 13/760,089, filed Feb. 6, 2013 and entitled CONTACTLESS REPLACEMENT FOR CABLED STANDARDS-BASED INTERFACES, which in turn claims the benefit under 35 U.S.C. §119(e) of U.S. Provisional Patent Application No. 61/467,334, filed Mar. 22, 2012; (2) U.S. patent application Ser. No. 13/776,727, filed Feb. 26, 2013 and entitled CONTACTLESS AUDIO ADAPTER, AND METHODS, which in turn claims the benefit under 35 U.S.C. §119(e) of U.S. Provisional Patent Application No. 61/467,334, filed Mar. 22, 2012; and (3) U.S. patent application Ser. No. 13/848,735, filed Mar. 22, 2013 and entitled CONTACTLESS DATA TRANSFER, which in turns claims the benefit under 35 U.S.C. §119(e) of U.S. Provisional Patent Application No. 61/786,522, filed Mar. 15, 2013.

U.S. patent application Ser. No. 13/427,576 is also incorporated by reference in its entirety.

### TECHNICAL FIELD OF THE DISCLOSURE

This disclosure generally relates to devices, systems, and methods for EHF communications, including communications using dielectric guiding structures and beam focusing structures.

### BACKGROUND OF THE DISCLOSURE

Advances in semiconductor manufacturing and circuit design technologies have enabled the development and production of ICs with increasingly higher operational frequencies. In turn, electronic products and systems incorporating such integrated circuits are able to provide much greater functionality than previous generations of products. This additional functionality has generally included the processing of increasingly larger amounts of data at increasingly higher speeds.

Many electronic systems include multiple printed circuit boards (PCBs) upon which these high-speed ICs are mounted, and through which various signals are routed to and from the ICs. In electronic systems with at least two PCBs and the need to communicate information between those PCBs, a variety of connector and backplane architectures have been developed to facilitate information flow between the boards. Unfortunately, such connector and backplane architectures introduce a variety of impedance discontinuities into the signal path, resulting in a degradation of signal quality or integrity. Connecting to boards by conventional means, such as signal-carrying mechanical connectors, generally creates discontinuities, requiring expensive electronics to negotiate. Conventional mechanical connectors may also wear out over time, require precise alignment and manufacturing methods, and are susceptible to mechanical jostling.

These characteristics of conventional connectors can lead to degradation of signal integrity and instability of electronic systems needing to transfer data at very high rates, which in turn limits the utility of such products. The detrimental characteristics of conventional connectors lead to degradation of signal integrity and corresponding instability of electronic systems that are designed to transfer data at very high rates, which in turn limits the utility of such systems. Methods and systems are needed for coupling discontinuous portions of high-data-rate signal paths without the cost and power consumption associated with insertable physical connectors and equalization circuits. Additionally, methods and systems are needed to ensure that such solutions are easily manufactured, modular, and efficient.

Examples of such systems are disclosed in U.S. Pat. No. 5,621,913 and U.S. patent application Ser. No. 12/655,041. The disclosures of these and all other publications referenced herein are incorporated by reference in their entirety for all purposes.

### SUMMARY OF THE DISCLOSURE

In one embodiment, the invention is directed to dielectric conduits for the propagation of an electromagnetic EHF signal having at least one known wavelength, where the dielectric conduits include an elongate body of a first dielectric material extending continuously along a longitudinal axis between a first terminus and a second terminus, where at each point along the longitudinal axis an orthogonal cross-section of the elongate body has a first dimension along a major axis of the cross-section, where the major axis extends along the largest dimension of the cross-section, and a second dimension along a minor axis of the cross-section, where the minor axis extends along a widest dimension of the cross-section that is at a right angle to the major axis; and for each cross-section of the elongate body, the first dimension is greater than the known wavelength of the electromagnetic EHF signal and the second dimension is less than the known wavelength of the electromagnetic EHF signal.

In this embodiment, the elongate body has a surface, where at least a quarter of the area of the surface is covered by a first reflective cladding that is a reflective material or a combination of reflective materials configured to reflect the electromagnetic EHF signal when propagated along the length of the elongate body.

In another embodiment, the invention relates to a conduit for propagation of electromagnetic EHF signals, the conduit including a plurality of elongate bodies of dielectric material, each elongate body configured for propagation of an independent electromagnetic EHF signal, and the dielectric material of each elongate body being the same or different. Each of the elongate bodies extends continuously along a longitudinal axis between a first terminus and a second terminus, and at each point along the longitudinal axis an orthogonal cross-section of each elongate body has a first dimension along a major axis of the cross-section, where the major axis is defined as the largest dimension of the cross-section, and a second dimension along a minor axis of the cross-section, where the minor axis is defined as a widest dimension of the cross-section that is at a right angle to the major axis.

For each such cross-section of each elongate body, the first dimension is greater than a known wavelength of the electromagnetic EHF signal to be propagated along that elongate body, and the second dimension is less than the known wavelength of the electromagnetic EHF signal to be propagated along that elongate body. Further, for at least a portion of each of the plural elongate bodies, the plural elongate bodies extends in combination and adjacent one another, where each elongate body is separated from each adjacent elongate body by a first reflective cladding that is a reflective material or combination of reflective materials configured to reflect the electromagnetic EHF signals propagated along the lengths of the elongate bodies.

In yet another embodiment, the invention relates to a method of propagating an electromagnetic EHF signal along a conduit as described above, where the method includes transmitting an electromagnetic EHF signal using an electromagnetic EHF transmitter; disposing the first terminus of the elongate body of the conduit adjacent the EHF transmitter so that at least a portion of the transmitted electromagnetic EHF signal is directed into the elongate body via the first terminus; and propagating the directed portion of the electromagnetic EHF signal along the elongate body to the second terminus of the elongate body.

### BRIEF DESCRIPTION OF DRAWINGS

Embodiments are described with reference to the accompanying drawings. In the drawings, like reference numbers may indicate identical or functionally similar elements.

FIG. 1 is side view of an EHF communication chip showing some internal components, in accordance with an embodiment of the present invention.

FIG. 2 is an isometric view of the EHF communication chip of FIG. 1.

FIG. 3 is a perspective view of a segment of dielectric conduit according to an embodiment of the present invention.

FIGS. 4A-4C are cross-section views of representative dielectric conduits according to selected embodiments of the present invention.

FIG. 5 is a perspective view of a dielectric conduit according to another embodiment of the present invention.

FIG. 6 is a semi-schematic side elevation view of an EHF electromagnetic communication system, according to yet another embodiment of the present invention.

FIG. 7 is a schematic depiction of an alternative EHF electromagnetic communication system, according to another embodiment of the present invention.

FIG. 8 is a perspective view of an exemplary coupling feature, according to an embodiment of the present invention.

FIG. 9 is a semi-schematic illustration of a coupling feature according to an embodiment of the present invention, adjacent to an EHF signal source.

FIG. 10 is a semi-schematic illustration of an alternative coupling feature according to an embodiment of the present invention, adjacent to an EHF signal source.

FIG. 11 depicts a portion of a dielectric conduit according to an embodiment of the present invention.

FIG. 12 depicts a portion of an alternative dielectric conduit according to an embodiment of the present invention.

FIG. 13 depicts a portion of yet another alternative dielectric conduit according to an embodiment of the invention.

FIG. 14 is a flowchart illustrating a method according to an embodiment of the present invention.

While the present disclosure is amenable to various modifications and alternative forms, specific embodiments are shown by way of example in the drawings and are described in detail. It should be understood, however, that the drawings and detailed description thereto are not intended to limit the present disclosure to the particular form disclosed, but on the contrary, the intention is to cover all modifications, equivalents, and alternatives falling within the spirit and scope of the present disclosure as defined by the appended claims.

### DETAILED DESCRIPTION OF THE DISCLOSURE

In the following description, numerous specific details are set forth to provide a thorough understanding of the present disclosure. Reference will be made to certain embodiments of the disclosed subject matter, examples of which are illustrated in the accompanying drawings. While the disclosed subject matter will be described in conjunction with the embodiments, it will be understood that it is not intended to limit the disclosed subject matter to these particular embodiments alone. On the contrary, the disclosed subject matter is intended to cover alternatives, modifications and equivalents that are within the spirit and scope of the disclosed subject matter as defined by the appended claims. In other instances, well known process steps have not been described in detail in order to avoid unnecessarily obscuring the present disclosure.

Moreover, in the following description, numerous specific details are set forth to provide a thorough understanding of the presently disclosed matter. However, it will be apparent to one of ordinary skill in the art that the disclosed subject matter may be practiced without these particular details. In other instances, methods, procedures, and components that are well known to those of ordinary skill in the art are not described in detail to avoid obscuring aspects of the present disclosed subject matter.

Devices, systems, and methods involving dielectric couplers for EHF communication are shown in the drawings and described below.

Devices that provide communication over a communication link may be referred to as communication devices or communication units. A communication unit that operates in the EHF band may be referred to as an EHF communication unit, for example. An example of an EHF communications unit is an EHF comm-link chip. Throughout this disclosure, the terms comm-link chip, comm-link chip package, and EHF communication link chip package will be used interchangeably to refer to EHF antennas embedded in IC packages. Examples of such comm-link chips are described in detail in U.S. Provisional Patent Application Ser. Nos. 61/491,811, 61/467,334, and 61/485,1103, all of which are hereby incorporated in their entireties for all purposes.

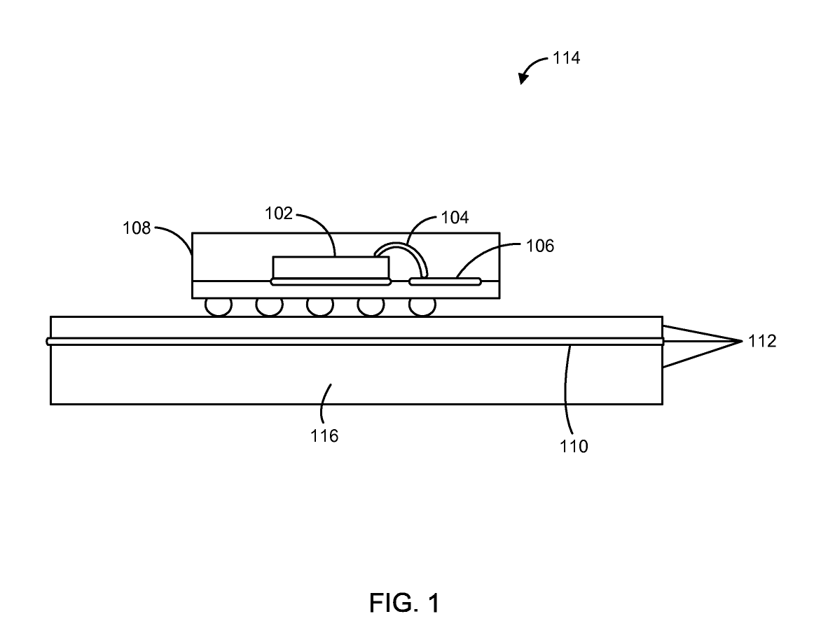

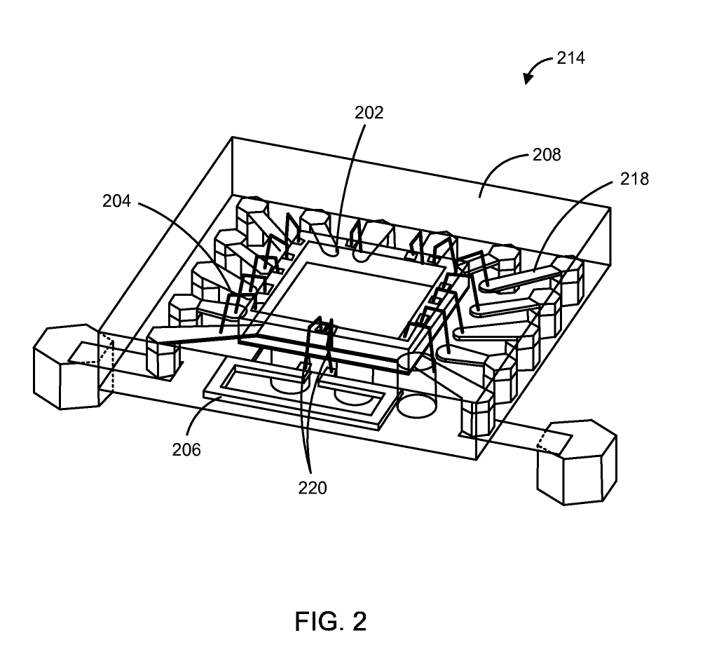

FIG. 1 is a side view of an exemplary extremely high frequency (EHF) communication chip 114 showing some internal components, in accordance with an embodiment. As discussed with reference to FIG. 1, the EHF communication chip 114 may be mounted on a connector printed circuit board (PCB) 116 of the EHF communication chip 114. FIG. 2 shows a similar illustrative EHF communication chip 214. It is noted that FIG. 1 portrays the EHF communication chip 114 using computer simulation graphics, and thus some components may be shown in a stylized fashion. The EHF communication chip 114 may be configured to transmit and receive extremely high frequency signals. As illustrated, the EHF communication chip 114 can include a die 102, a lead frame (not shown), one or more conductive connectors such as bond wires 104, a transducer such as antenna 106, and an encapsulating material 108. The die 102 may include any suitable structure configured as a miniaturized circuit on a suitable die substrate, and is functionally equivalent to a component also referred to as a “chip” or an “integrated circuit (IC).” The die substrate may be formed using any suitable semiconductor material, such as, but not limited to, silicon. The die 102 may be mounted in electrical communication with the lead frame. The lead frame (similar to 218 of FIG. 2) may be any suitable arrangement of electrically conductive leads configured to allow one or more other circuits to operatively connect with the die 102. The leads of the lead frame (See 218 of FIG. 2) may be embedded or fixed in a lead frame substrate. The lead frame substrate may be formed using any suitable insulating material configured to substantially hold the leads in a predetermined arrangement.

Further, the electrical communication between the die 102 and leads of the lead frame may be accomplished by any suitable method using conductive connectors such as, one or more bond wires 104. The bond wires 104 may be used to electrically connect points on a circuit of the die 102 with corresponding leads on the lead frame. In another embodiment, the die 102 may be inverted and conductive connectors including bumps, or die solder balls rather than bond wires 104, which may be configured in what is commonly known as a “flip chip” arrangement.

The antenna 106 may be any suitable structure configured as a transducer to convert between electrical and electromagnetic signals. The antenna 106 may be configured to operate in an EHF spectrum, and may be configured to transmit and/or receive electromagnetic signals, in other words as a transmitter, a receiver, or a transceiver. In an embodiment, the antenna 106 may be constructed as a part of the lead frame (see 218 in FIG. 2). In another embodiment, the antenna 106 may be separate from, but operatively connected to the die 102 by any suitable method, and may be located adjacent to the die 102. For example, the antenna 106 may be connected to the die 102 using antenna bond wires (similar to 220 of FIG. 2). Alternatively, in a flip chip configuration, the antenna 106 may be connected to the die 102 without the use of the antenna bond wires (see 220). In other embodiments, the antenna 106 may be disposed on the die 102 or on the PCB 116.

Further, the encapsulating material 108 may hold the various components of the EHF communication chip 114 in fixed relative positions. The encapsulating material 108 may be any suitable material configured to provide electrical insulation and physical protection for the electrical and electronic components of first EHF communication chip 114. For example, the encapsulating material 108 may be a mold compound, glass, plastic, or ceramic. The encapsulating material 108 may be formed in any suitable shape. For example, the encapsulating material 108 may be in the form of a rectangular block, encapsulating all components of the EHF communication chip 114 except the unconnected leads of the lead frame. One or more external connections may be formed with other circuits or components. For example, external connections may include ball pads and/or external solder balls for connection to a printed circuit board.

Further, the EHF communication chip 114 may be mounted on a connector PCB 116. The connector PCB 116 may include one or more laminated layers 112, one of which may be PCB ground plane 110. The PCB ground plane 110 may be any suitable structure configured to provide an electrical ground to circuits and components on the PCB 116.

FIG. 2 is a perspective view of an EHF communication chip 214 showing some internal components. It is noted that FIG. 2 portrays the EHF communication chip 214 using computer simulation graphics, and thus some components may be shown in a stylized fashion. As illustrated, the EHF communication chip 214 can include a die 202, a lead frame 218, one or more conductive connectors such as bond wires 204, a transducer such as antenna 206, one or more antenna bond wires 220, and an encapsulating material 208. The die 202, the lead frame 218, one or more bond wires 204, the antenna 206, the antenna bond wires 220, and the encapsulating material 208 may have functionality similar to components such as the die 102, the lead frame, the bond wires 104, the antenna 106, the antenna bond wires, and the encapsulating material 108 of the EHF communication chip 114 as described in FIG. 1. Further, the EHF communication chip 214 may include a connector PCB (similar to PCB 116).

In FIG. 2, it may be seen that the die 202 is encapsulated in the EHF communication chip 214, with the bond wires 204 connecting the die 202 with the antenna 206. In this embodiment, the EHF communication chip 214 may be mounted on the connector PCB. The connector PCB (not shown) may include one or more laminated layers (not shown), one of which may be PCB ground plane (not shown). The PCB ground plane may be any suitable structure configured to provide an electrical ground to circuits and components on the PCB of the EHF communication chip 214.

With continuing references to FIGS. 1-2, the EHF communication chip 214 may be included and configured to allow EHF communication with the EHF communication chip 114. Further, either of the EHF communication chips 114 or 214 may be configured to transmit and/or receive electromagnetic signals, providing one or two-way communication between the EHF communication chip 114 and the EHF communication chip 214 and accompanying electronic circuits or components. In an embodiment, the EHF communication chip 114 and the EHF communication chip 214 may be co-located on the single PCB and may provide intra-PCB communication. In another embodiment, the EHF communication chip 114 may be located on a first PCB (similar to PCB 116) and the EHF communication chip 214 may be located on a second PCB (similar to PCB 116) and may therefore provide inter-PCB communication.

In some situations a pair of EHF communication chips such as 114 and 214 may be mounted sufficiently far apart that EHF electromagnetic signals may not be reliably exchanged between them. In these cases it may be desirable to provide improved signal transmission between a pair of EHF communication chips. To that end, the present invention provides a dielectric conduit configured for the propagation of electromagnetic EHF signals, as described below and shown in the drawings.

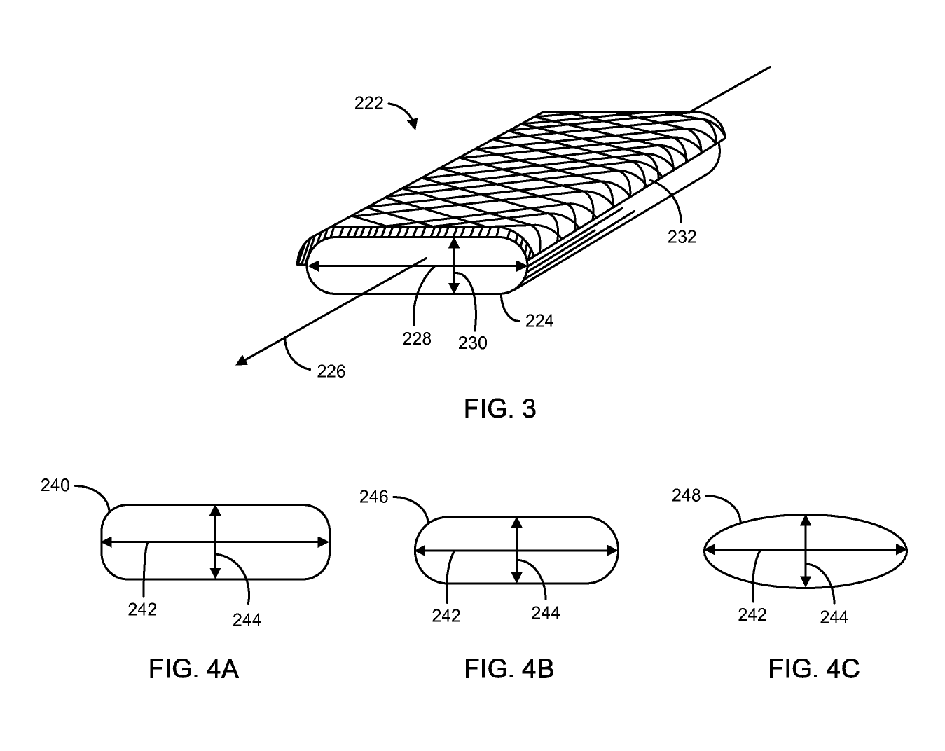

FIG. 3 is a perspective view of a segment of an exemplary dielectric conduit 222, in accordance with an embodiment of the invention. Hereinafter, the dielectric conduit 222 may additionally or alternatively be referred to as a waveguide or dielectric waveguide.

The dielectric conduit 222 includes an elongate body 224 that includes a first dielectric material. The elongate body 224 typically extends along a longitudinal axis 226 of the elongate conduit 222. The elongate body includes a first dielectric material preferably having a dielectric constant of at least about 2.0. Materials having significantly higher dielectric constants may result in a reduction of the preferred dimensions of the elongate body, due to a reduction in wavelength when an EHF signal enters a material having a higher dielectric constant. Preferably, the elongate body includes a plastic material that is a dielectric material.

The elongate body 224 is shaped so that at each point along the longitudinal axis 226, a cross-section of the elongate body 224 orthogonal to the longitudinal axis would exhibit a major axis extending across the cross-section along the largest dimension of the cross-section, and minor axis of the cross-section extending across the cross-section along the largest dimension of the cross-section that is oriented at a right angle to the major axis. For each such cross-section, the cross-section would have a first dimension 228 along its major axis, and a second dimension 230 along its minor axis.

In order to enhance the ability of the elongate body 224 to internally propagate an electromagnetic EHF signal, each elongate body is sized appropriately so that the length of the first dimension of each cross-section is greater than the wavelength of the electromagnetic EHF signal to be propagated along the conduit; and the second dimension is less than the wavelength of the electromagnetic EHF signal to be propagated along the conduit. In an alternative embodiment of the invention, the first dimension is greater than 1.4 times the wavelength of the electromagnetic EHF signal to be propagated, and the second dimension is not greater than about one-half of the wavelength of the electromagnetic EHF signal to be propagated.

Additionally, the propagation of an electromagnetic EHF signal by the elongate body may be enhanced by the presence of a cladding material 232 to an external surface of the dielectric elongate body 224. The nature of the surface(s) of the elongate body will vary according to the particular dimensions of each elongate body. Typically, however, considering the entire surface area of the elongate body, such surface is typically at least about one-quarter covered by a cladding material 232. In another embodiment, at least one-half of the surface of the elongate body is covered by the first reflective cladding, as shown in FIG. 3 for cladding material 232. In yet another alternative embodiment of the invention, the entire surface of the elongate body is covered by the first reflective cladding. The cladding applied to a elongate body may include a single reflective material, or multiple reflective materials. The cladding may include a different reflective material on different faces, or surfaces, of the elongate body.

For every embodiment, the cladding material may be applied as a continuous cladding, with substantially no defects or apertures in the material. In another embodiment, the cladding material may include a plurality of apertures, such as regularly or irregularly spaced voids, or the interstices present in a braided or woven cladding, as shown in FIG. 3 for cladding material 232.

Appropriate cladding materials include materials capable of reflecting the electromagnetic EHF signal to be propagated along the elongate body 224. Reflective materials appropriate for use as cladding may include conductive materials, dissipative materials, or other dielectric materials. Where the cladding includes a conductive material, the conductive material may include a conductive metal or metals. Where the cladding includes an additional dielectric material, for example the air surrounding the elongate body, where the second dielectric material typically has a dielectric constant that is less than the dielectric constant of the conduit.

The depictions of the cladding in the accompanying drawings are not intended to reflect the actual dimensions of the cladding material, which has been exaggerated for the sake of clarity. The thickness of cladding material layer sufficient to reflect electromagnetic EHF signals can be quite thin, and typically only a very thin layer is required in order to satisfactorily reflect the propagated signal. For example, where the cladding material is a conductive metal, a very thin metal foil is typically sufficient for most purposes. In general, any thickness of cladding material sufficient to reflect internal electromagnetic EHF signals satisfactorily is a sufficient thickness for the purposes of the present invention. Alternatively, the thickness of the cladding material may be determined in part by manufacturing and use considerations.

Loss of signal in the dielectric conduit may be reduced by employing a single mode rectangular mode waveguide employing a transverse electric (TE) propagation mode. Alternatively, the conduit may employ a hybrid propagation mode that is neither pure transverse electric (TE) mode or transverse magnetic (TM) mode, with Eₘₙ^{y} and Eₘₙ^{x}, where m and n refer to the number of extrema, i.e. maxima and minima, respectively. In an exemplary scenario, the fundamental mode of each family can be expressed as E₁₁^{y} and E₁₁^{x}.

For either family of propagation mode, the cut-off frequency may be defined as:

$$f = \frac{c}{2 π \sqrt{{e}_{r}}} \sqrt{{k}_{x}^{2} + {k}_{y}^{2}} \qquad ( 2 )$$

where kₓ and k_{y} are the transverse propagation constants along the x and y direction. In an exemplary scenario, assuming that the field is polarized along x-axis, kₓ and k_{c} can be approximated as:

$$\begin{matrix}{k}_{x} = \frac{m π}{a} {( 1 + \frac{{n}_{3}^{2} {A}_{3} {n}_{5}^{2} {A}_{5}}{π {n}_{1}^{2} a} )}^{- 1} & ( 3 ) \\ {k}_{y} = \frac{n π}{b} {( 1 + \frac{{A}_{2} + {A}_{4}}{π b} )}^{- 1} & ( 4 ) \\ {A}_{2 , 3 , 4 , 5} = \frac{λ}{2 \sqrt{{n}_{1}^{2} - {n}_{2 , 3 , 4 , 5}^{2}}} & ( 5 )\end{matrix}$$

In one example, the elongate body of the conduit is composed of a polyethylene plastic, such as LDPE or HDPE, and the frequency of the electromagnetic EHF signal to be propagated along the conduit is 60 GHz. For the exemplary conduit, m=1, n=1, the width a=2 mm, the height b=1 mm, n1=1.5, and n2=n3=n4=n5=1. Using equations (2)-(5), the cutoff frequency of the exemplary conduit can be calculated to be about 56 GHz, which indicates that the operating frequency of 60 GHz is appropriate for signal transmission through the dielectric conduit.

Typically, as the a-dimension gets larger, the cut-off frequency becomes lower. In other words, the operating frequency may experience higher order mode propagation with larger dimension. In this example a polyethylene plastic is used as a waveguide or dielectric conduit, but alternative dielectric materials with low loss tangent, such as TEFLOT, polystyrene, glass, rubber, ceramic, and the like may also be used.

Higher order mode propagation may result in higher loss per transmission length as well as higher dispersion effect, within the interest of applications, such as 1 meter long USB cable, there can be tolerance for the ease of manufacturing and coupling efficiency. However, an exemplary polyethylene conduit having a width of 10 mm, and a thickness of 1.5 mm is capable of transmitting data of 6 Gb/s at up to 5 meters.

As shown, ‘n’ refers to refractive index defining speed of light in vacuum/speed of light in material. The ‘n’ may also be lower index of cladding material for near-total internal reflection. The elongate body of the dielectric conduit may be surrounded or enclosed by a variety of claddings having differing refractive indices. The refractive index of the cladding material is defined as the ratio of the speed of light in a vacuum to the phase speed of light in the cladding material (eᵣ), or:

n=\sqrt{eᵣ} (1)

For homogeneous and non-magnetic cladding materials, a total internal reflection of the electromagnetic EHF signal may be achieved when the refractive index of the cladding material smaller than that of the dielectric material of the elongate body core. Therefore, a bare rectangular dielectric strip can be used as an elongate body.

The elongate body 224 may have any of a variety of potential geometries, provided that the first dimension of each cross-section of the elongate body is greater than the wavelength of the electromagnetic EHF signal to be propagated, and the second dimension is less than the wavelength of the electromagnetic EHF signal to be propagated. Typically, the elongate body 224 is shaped so that each cross-section has an outline formed by some combination of straight and/or continuously curving line segments. In one embodiment, each cross-section has an outline that defines a rectangle, a rounded rectangle, a stadium, or a superellipse, where superellipse includes shapes including ellipses and hyperellipses.

For example, FIG. 4A illustrates a cross-section 240 that defines a rounded rectangle having a major axis 242 and a minor axis 244. FIG. 4B illustrates a cross-section 246 that defines a stadium, or capsule, having a major axis 242 and a minor axis 244. And FIG. 4C illustrates a cross-section 248 that defines an ellipse 248 having a major axis 242 and a minor axis 244.

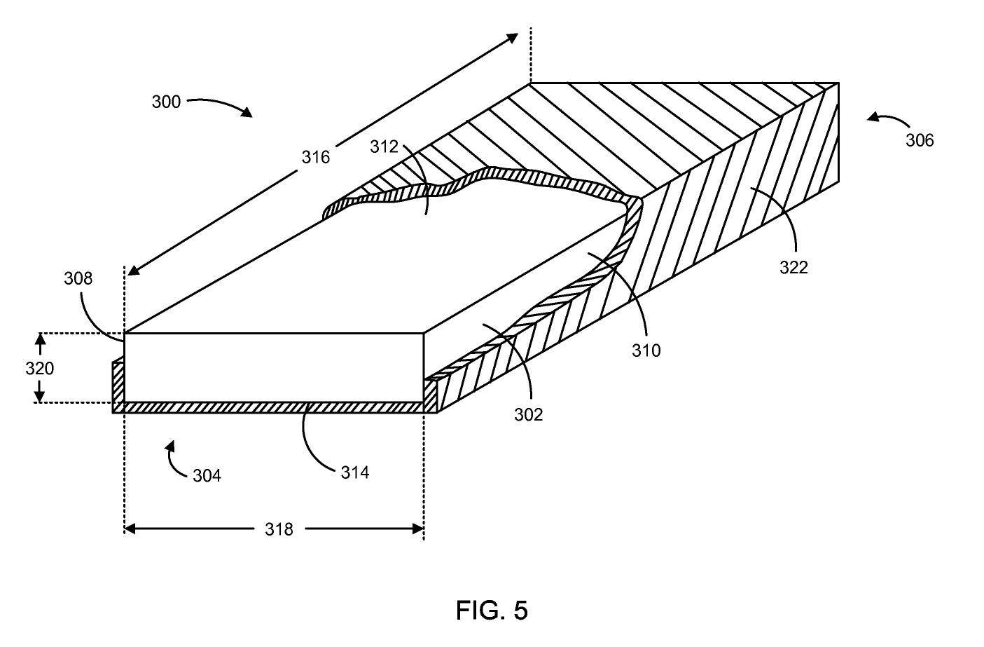

In one embodiment, as shown in FIG. 5, a dielectric conduit 300 may include an elongate body 302 of a first dielectric material, where the elongate body 302 extends along a longitudinal axis from a first terminus 304 to a second terminus 306, the distance between the first and second terminus corresponding to a length 316 of the elongate body 302.

The elongate body 302 defines an elongate cuboid. That is, elongate body 302 is shaped so that at each point along its longitudinal axis, a cross-section of the elongate body 302 orthogonal to the longitudinal axis defines a rectangle. The elongate body 302 includes a first lateral surface 308 and a second lateral surface 310 spaced from the first lateral surface, with the distance 318 that separates the first and second lateral surfaces defining a width of the elongate body along a major axis. Similarly, elongate body 302 includes a first major surface 312 and a second major surface 314 spaced from the first major surface, with the distance 320 separating the first and second major surfaces defining the depth of the elongate body along a minor axis.

The dielectric conduit 300 of FIG. 5 additionally includes a cladding 322, where the cladding includes a reflective material, or more than one reflective material, surrounding the elongate body 302 on each lateral surface 308, 310 and major surface 312, 314, as shown in a partial cutaway view in FIG. 5.

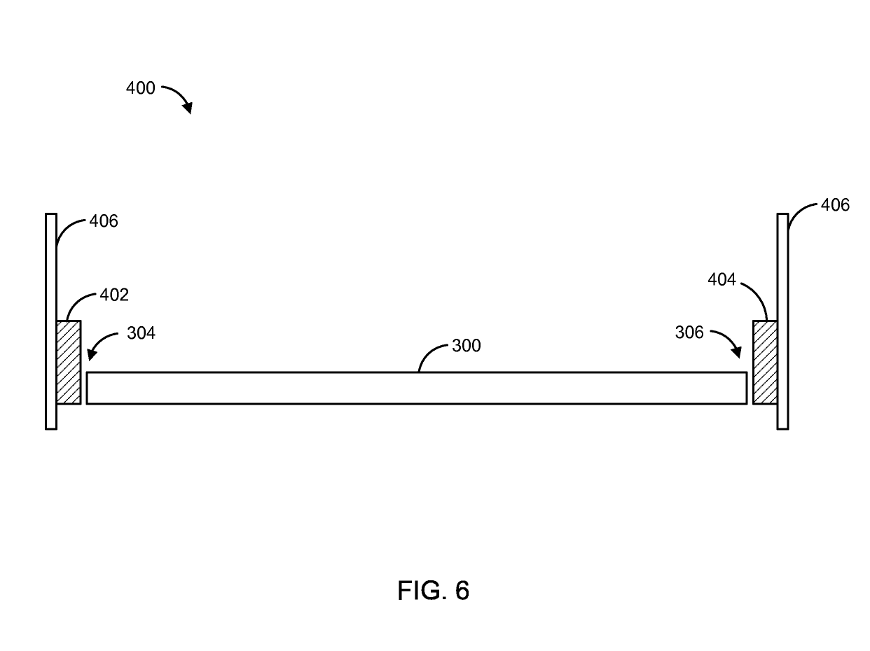

The dielectric conduits of the present invention may be used to enhance propagation of an EHF electromagnetic signal between EHF comm-chips in an EHF electromagnetic communication system. As shown in FIG. 6, a representative EHF electromagnetic communication system 400 is shown including a dielectric conduit 300 having a first terminus 304 and a second terminus 306. A first EHF comm-chip 402 is disposed adjacent the first terminus 304, while a second EHF comm-chip 404 is disposed adjacent the second terminus 306. Each comm-chip is optionally attached to a substrate, such as a PCB substrate 406.

During use, an EHF-frequency electromagnetic signal may be launched into the dielectric conduit 300 from first EHF comm-chip 402 adjacent to terminus 304, provided that comm-chip 402 is configured to act as a transmission source of an EHF electromagnetic signal having an appropriate wavelength for the dielectric conduit. The signal may then be propagated along the length of conduit 300 and to the second terminus 306 of the dielectric conduit, where it may be received by second comm-chip 404 adjacent the second terminus 306, provided that comm-chip 306 is configured to act as a receiver for an EHF electromagnetic signal. The dielectric conduit may be used to propagate in a single direction, for example from a dedicated transmission source to a dedicated receiver. Alternatively, and more typically, the dielectric conduit may conducts EHF signals in either or both directions, to and from transducers that may transmit or receive such signals.

The dielectric conduits of the present invention may be rigid, or they may be more or less flexible in order to accommodate various a range of distances and orientations between EHF comm-chips to be connected by the conduit. The dielectric conduits of the present invention may include a connector element or fastener at one or both ends for attaching the conduit 300 in place, for attaching the conduit 300 to one or more devices associated with the transmitting and receiving IC packages, or for attaching the conduit directly to the transmitting and/or receiving IC packages. The dielectric conduit 300 is optionally disposed on, or partially embedded in, an electrically conductive surface, particularly where it may be used in an electronic device.

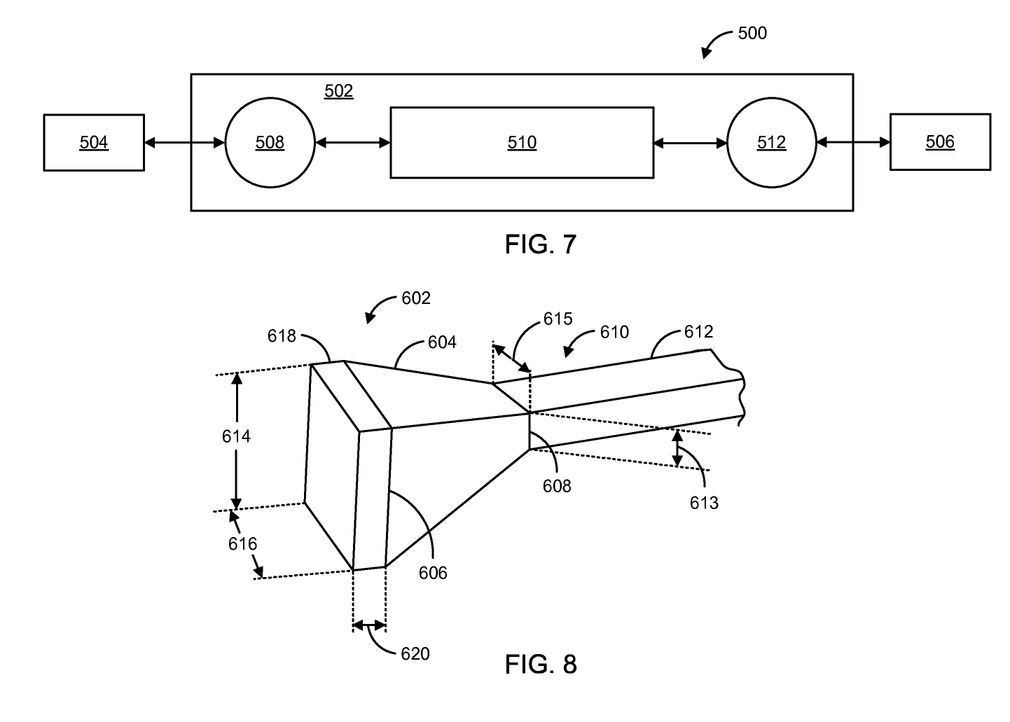

At least one of the first and second terminus of a dielectric conduit of the present invention may further include a coupling feature configured to enhance the transmission of the EHF signal. For example, the coupling feature may be configured to enhance a transmission of an external electromagnetic EHF signal into the elongate body of the first dielectric material and/or enhance a transmission of the electromagnetic EHF signal out of the elongate body of the first dielectric material. An EHF electromagnetic communication system incorporating a first and second coupling feature is depicted schematically in FIG. 7. As shown, EHF communication system 500 includes a dielectric conduit 502 configured to facilitate propagation of an EHF electromagnetic signal between a first EHF comm-chip 504 and a second EHF comm-chip 506. Dielectric conduit 502 further incorporates a first coupling feature 508 at the interface between the elongate cuboid 510 of the dielectric conduit 502 and first comm-chip 504, and a second coupling feature 512 at the interface between the elongate cuboid 510 and second comm-chip 506.

The coupling feature may be any structure that serves to propagate, focus, and/or transmit an EHF electromagnetic signal from an adjacent EHF signal source, such as an EHF transmitter or transducer, a terminus of the elongate cuboid. The coupling feature may include one or more dielectric materials, which may be the same or different from the first dielectric material of the elongate cuboid. The geometry of the coupling feature may be selected to maximize the signal energy that is transferred into the elongate cuboid, for example by incorporating a dielectric lens or dielectric horn.

In one embodiment of the invention, the dielectric conduit incorporates one or more coupling features that in turn may include one or more of one of a dielectric lens, a dielectric horn, a dielectric interface plate, and a dielectric transformer. A dielectric horn typically is configured to capture a maximal amount transmitted EHF energy from an EHF signal source for transfer to the elongate cuboid. For example, the coupling feature may include a dielectric horn that defines a rectangular-pyramidal frustum, as shown for coupling feature 602 of FIG. 8, which is coupled to an elongate body 612 of a dielectric material that is an elongate cuboid.

Coupling feature 602 includes a rectangular pyramidal frustum 604 composed of a dielectric material, which may be the same or different than the first dielectric material of the elongate body 612. The rectangular pyramidal frustum 604 includes a base 606 and an apex 608, and is coupled to terminus 610 of an elongate cuboid 612 via the apex 608. The rectangular-pyramidal frustum 604 has an apex height 613 and an apex width 615, where apex height 613 is substantially equal to the height of elongate cuboid 612 to which it is coupled, and the apex width 615 of the rectangular-pyramidal frustum is typically substantially equal to the width of the elongate cuboid 612 to which it is coupled. Each of the frustum height and width may increase from their values at the apex 608 of the frustum 604 to the base 606 of the frustum 604. In one embodiment of the invention, the frustum height and width increase linearly from their values at the apex 608 of the frustum 604 to a base height 614 and a base width 616 at the base 616 of the frustum 604. It will be appreciated that the coupling features may have other configurations appropriate for coupling to conduits having different cross-sectional configurations.

Coupling feature 602 may optionally further include a dielectric interface plate 618 coupled to the base 606 of the rectangular-pyramidal frustum 604 and having a height and a width substantially equal to corresponding base height 614 and base width 616 of the rectangular-pyramidal frustum 604. The dielectric interface plate 618 additionally may define a plate thickness 620 that is substantially equal to one-quarter of the wavelength of the EHF signal that is expected to be propagated by the elongate body 612. The dielectric interface plate 618 may have a dielectric constant that is distinct from a dielectric constant of the coupling feature.

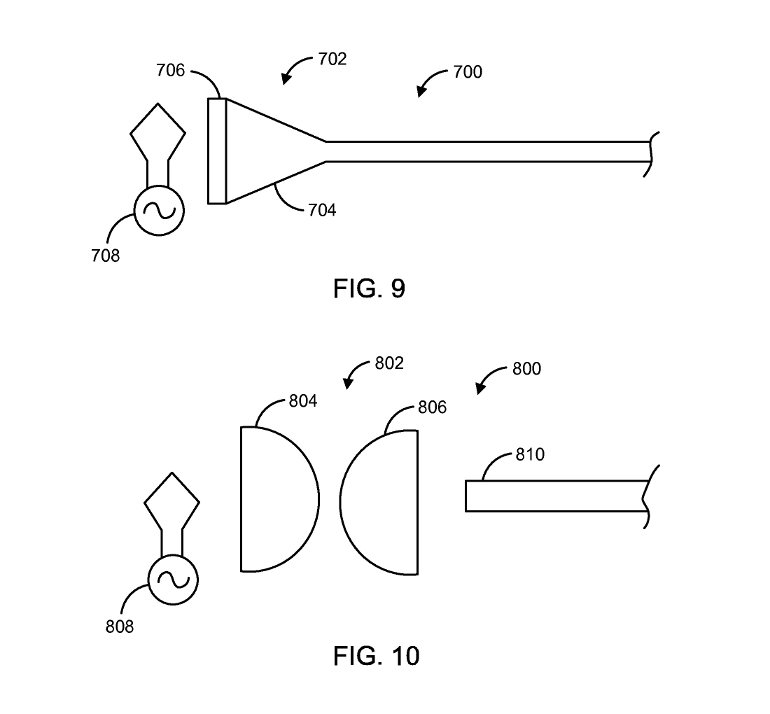

FIG. 9 is a semi-schematic depiction of a dielectric conduit 700, where the conduit incorporates a coupling feature 702 that includes a dielectric horn 704 and dielectric interface plate 706. The coupling feature 702 is positioned adjacent an EHF electromagnetic signal source 708, in order to maximize the transfer of EHF signal into the terminus of the conduit for propagation.

In an alternative embodiment of the invention, the dielectric conduit may incorporate a coupling feature having one or more dielectric lenses, where the lenses are positioned appropriately to maximize the transfer of an incident EHF electromagnetic signal into the terminus of the conduit for propagation. A wide variety of dielectric lenses may be utilized for this purpose, including concave lenses, convex lenses, fresnel lenses, etc., and the coupling feature may be configured to couple to conduits having different cross-sectional dimensions as discussed above.

FIG. 10 is a semi-schematic depiction of a dielectric conduit 800, where the conduit incorporates a coupling feature 802 that includes a first dielectric lens 804 and second dielectric lens 806. The coupling feature 802 is positioned adjacent an EHF electromagnetic signal source 808, in order to capture the incident EHF signal. Typically, the dielectric lenses 804, 806 of the coupling feature would be oriented and spaced so that a focal point of the refracted EHF radiation intersects a terminus 810 of the dielectric conduit.

The location of the focal point for one or more dielectric lenses may be estimated using Snell's law, which describes the behavior of electromagnetic waves as they pass through a boundary between different media, such as water, glass and air. More specifically, Snell's law states that the relationship between the sines of the angles of incidence and refraction is equivalent to the ratio of the phase velocities in the two media, or equivalent to the reciprocal of the ratio of the indices of refraction:

$$\frac{sin {θ}_{1}}{sin {θ}_{2}} = \frac{{υ}_{1}}{{υ}_{2}} = \frac{{n}_{2}}{{n}_{1}}$$

with each θ being the angle that is measured from the normal of the boundary for the incident wave (θ₁) and for the refracted wave (θ₂), v being the velocity of light in each respective medium (typically measured in meters per second, or m/s), and n being the refractive index (which is unitless) of each respective medium.

In other embodiments of the invention, dielectric conduit may incorporate plural elongate bodies of dielectric material, in order to form a dielectric conduit that may propagate multiple independent EHF signals, or to minimize spurious radiation by disabling the function of the dielectric conduit until two shielding structures are present to at least partially surround the collective dielectric conduit.

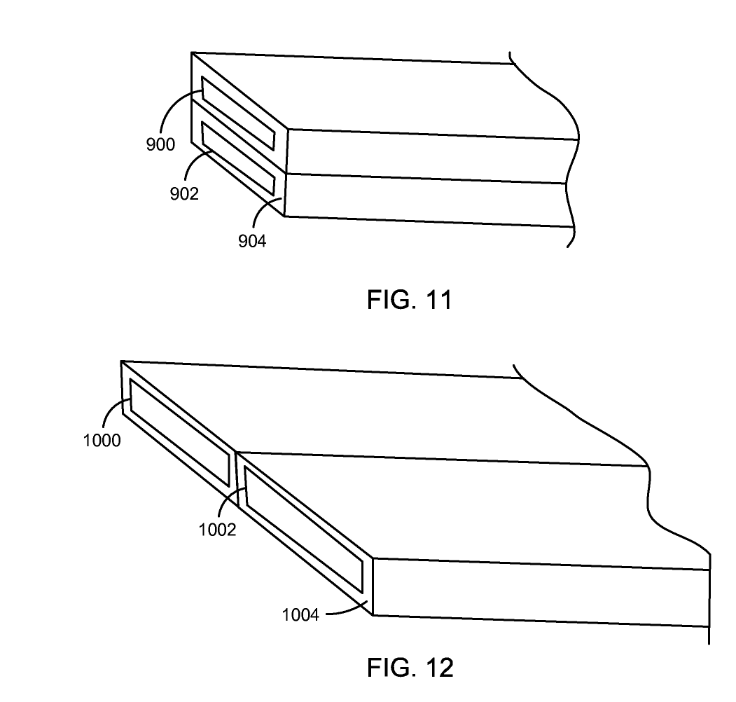

Typically, where the dielectric conduit includes plural dielectric bodies, each additional elongate body extends at least partially along and adjacent to the first elongate body, and each elongate body may be separated from each other elongate body by a first or second cladding that includes a first or second reflective material. In one embodiment, shown in FIG. 11, an exemplary combination waveguide includes a first elongate dielectric cuboid 900 and a second elongate dielectric cuboid 902 arranged side-by-side, that is, arranged so that a lateral side of the first elongate cuboid 900 abuts a lateral side of the second elongate cuboid 902. In an alternative embodiment, shown in FIG. 12, another exemplary combination waveguide includes a first elongate dielectric cuboid 1000 and a second elongate dielectric cuboid 1002 arranged in a stack, that is arranged so that a major surface of the first elongate cuboid 1000 abuts a major surface of the second elongate cuboid 1002.

In both embodiments, at least one of the first and second major surfaces of the first or second elongate cuboid may be substantially covered by an appropriate cladding that includes a reflective material. In the embodiment of FIG. 11, the first and second elongate cuboids 900, 902 are completely encased and separated by a cladding material 904, while in FIG. 11 first and second elongate cuboids 1000, 1002 are completely encased and separated by a cladding material 1004.

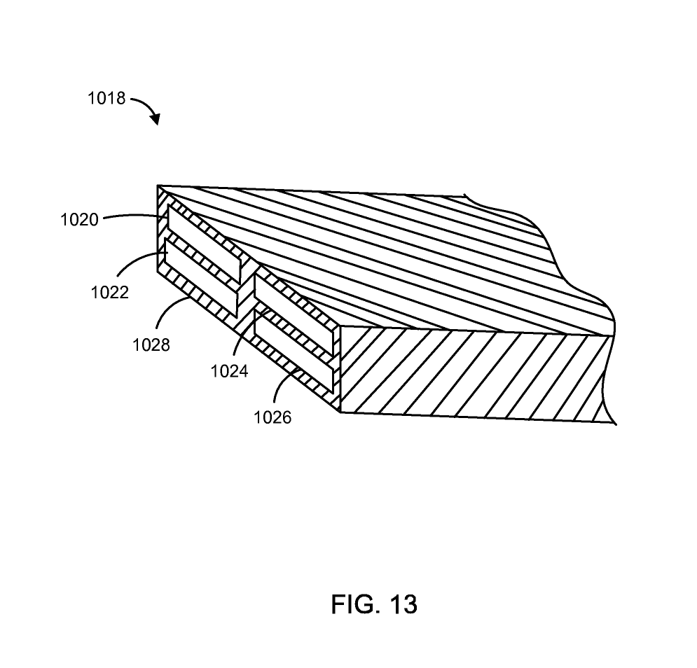

In yet another embodiment, depicted in FIG. 13, the dielectric conduit 1018 includes four individual elongate bodies of dielectric materials, separated and enclosed by cladding 1028, where the four individual elongate bodies are arranged in a two-by-two matrix.

Where the dielectric conduit of the present invention includes multiple elongate bodies for the propagation of multiple independent EHF signals, each elongate body may separate from each other elongate body simultaneously or in sequence, so that a terminus of each elongate body may be disposed adjacent a different EHF signal source and/or receiver.

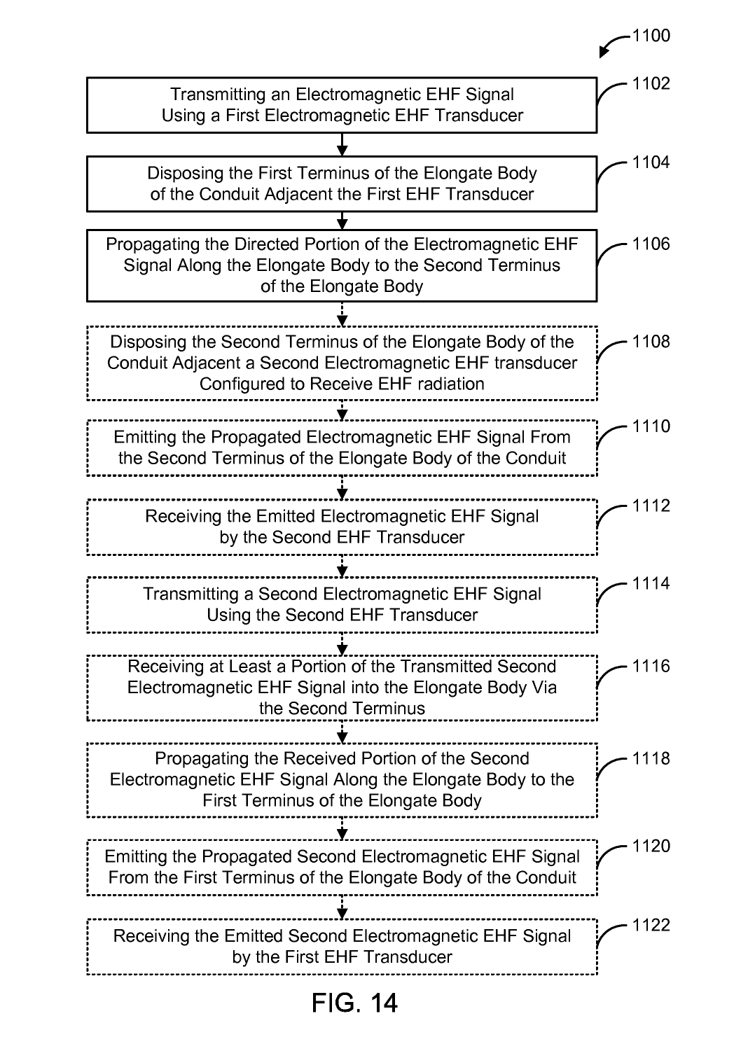

The dielectric conduits of the present invention lend themselves to a method of propagating an electromagnetic EHF signal along a conduit, as set out in flowchart 1100 of FIG. 14. Such a method may include transmitting an electromagnetic EHF signal using an electromagnetic EHF transmitter at 1102; disposing the first terminus of the elongate body of the conduit adjacent the EHF transmitter so that at least a portion of the transmitted electromagnetic EHF signal is directed into the elongate body via the first terminus at 1104; and propagating the directed portion of the electromagnetic EHF signal along the elongate body to the second terminus of the elongate body at 1106.

In some embodiments, the method may further include disposing the second terminus of the elongate body of the conduit adjacent an EHF receiver configured to receive EHF radiation at 1108; emitting the propagated electromagnetic EHF signal from the second terminus of the elongate body of the conduit at 1110; and receiving the emitted electromagnetic EHF signal by the EHF receiver at 1112.

In some embodiments, where the EHF transmitter may correspond to a first EHF transducer, and the EHF receiver may correspond to a second EHF transducer the method may yet further transmitting a second electromagnetic EHF signal using the second EHF transducer at 1114; receiving at least a portion of the transmitted second electromagnetic EHF signal into the elongate body via the second terminus at 1116; and propagating the received portion of the second electromagnetic EHF signal along the elongate body to the first terminus of the elongate body at 1118; emitting the propagated second electromagnetic EHF signal from the first terminus of the elongate body of the conduit at 1120; and receiving the emitted second electromagnetic EHF signal by the first EHF transducer at 1122.

Some embodiments of the present disclosure may also provide a system including an IC package assembly including an EHF communication chip disposed on a substrate including a conductive planar portion. The EHF communication chip may include a transducer and transmitting a transmit signal having an EHF frequency. The conductive planar portion of the substrate may be substantially reflective of the transmit signal. The system may also include an elongate dielectric coupler having a first end proximate the transducer of the EHF communication chip, a length, and a second end spaced from the first end. At least a portion of the transmit signal may pass into the dielectric coupler at the first end and may propagate along the dielectric coupler or conduit away from the transducer. Further, the transmit signal may have a polarization characteristic that is maintained substantially the same throughout the length of the dielectric coupler.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A conduit for propagation of an electromagnetic EHF signal having at least one known wavelength, comprising:
an elongate body of a first dielectric material extending continuously along a longitudinal axis between a first terminus and a second terminus, where at each point along the longitudinal axis an orthogonal cross-section of the elongate body has a first dimension along a major axis of the cross-section, where the major axis extends along the largest dimension of the cross-section, and a second dimension along a minor axis of the cross-section, where the minor axis extends along a widest dimension of the cross-section that is at a right angle to the major axis;
where for each cross-section of the elongate body, the first dimension is greater than the known wavelength of the electromagnetic EHF signal and the second dimension is less than the known wavelength of the electromagnetic EHF signal; and
the elongate body having a surface, where at least a quarter of the area of the surface is covered by a first reflective cladding that is a reflective material or a combination of reflective materials configured to reflect the electromagnetic EHF signal when propagated along the length of the elongate body.

2. The conduit of claim 1, where for each cross-section of the elongate body, the first dimension is greater than 1.4 times the known wavelength of the electromagnetic EHF signal, and the second dimension is not greater than half of the known wavelength of the electromagnetic EHF signal.

3. The conduit of claim 1, wherein at least one half of the area of the surface of the elongate body is covered by the first reflective cladding.

4. The conduit of claim 1, wherein the first reflective cladding is a continuous cladding.

5. The conduit of claim 1, wherein the first reflective cladding includes a plurality of apertures.

6. The conduit of claim 1, wherein the first reflective cladding includes a conductive material, a dissipative material, or a second dielectric material having a dielectric constant that is lower than a dielectric constant of the first dielectric material.

7. The conduit of claim 1, wherein the first dielectric material has a dielectric constant of at least 2.0.

8. The conduit of claim 1, wherein the first reflective cladding is a second dielectric material that has a dielectric constant that is lower than the dielectric constant of the first dielectric material.

9. The conduit of claim 1, wherein each cross-section along the longitudinal axis corresponds to a shape formed by one or more straight or continuously curving line segments.

10. The conduit of claim 9, wherein each cross-section along the longitudinal axis defines a rectangle, a rounded rectangle, a stadium, or a superellipse.

11. The conduit of claim 10, wherein each cross-section along the longitudinal axis defines an ellipse or a hyperellipse.

12. The conduit of claim 9, wherein each cross-section along the longitudinal axis defines a rectangle, and the elongate body of the dielectric first material defines an elongate cuboid.

13. The conduit of claim 1, wherein the surface of the elongate body includes a first lateral surface and a second lateral surface spaced from the first lateral surface, a distance separating the first and second lateral surfaces defining the width of the elongate body along the major axis; and a first major surface and a second major surface spaced from the first major surface, a distance separating the first and second major surfaces defining the depth of the elongate body along the minor axis.

14. The conduit of claim 13, wherein at least one of the first and second major surfaces is covered with the first reflective cladding.

15. The conduit of claim 1, wherein at least one of the first and second termini includes a coupling feature, wherein the coupling feature is configured to enhance a transmission of an external electromagnetic EHF signal into the elongate body of the first material and/or enhance a transmission of the electromagnetic EHF signal out of the elongate body of the first material.

16. The conduit of claim 15, wherein the coupling feature includes at least one of a dielectric lens, a dielectric horn, a dielectric interface plate, and a dielectric transformer.

17. The conduit of claim 16, wherein each cross-section along the longitudinal axis defines a rectangle; the elongate body of the dielectric first material defines an elongate cuboid; and the coupling feature includes a dielectric horn that is a rectangular-pyramidal frustum of a dielectric material, the rectangular-pyramidal frustum having a base and an apex, wherein the apex of the rectangular-pyramidal frustum is coupled to the elongate body of dielectric first material at the first or second terminus.

18. The conduit of claim 17, wherein the apex of the rectangular-pyramidal frustum has an apex width substantially equal to the first dimension of the elongate cuboid, and an apex height substantially equal to the second dimension of the elongate cuboid.

19. The conduit of claim 17, wherein the rectangular-pyramidal frustum has a height and a width, and each of the frustum height and width increases linearly from the apex to the base of the rectangular-pyramidal frustum.

20. The conduit of claim 17, wherein the coupling feature further includes a dielectric interface plate coupled to the base of the rectangular-pyramidal frustum and having a height and a width substantially equal to that of the base of the rectangular-pyramidal frustum, and a plate thickness that is substantially equal to one-quarter of the known wavelength of the EHF signal.

21. The conduit of claim 20, wherein the dielectric interface plate has a relative dielectric constant that is different than a relative dielectric constant of the coupling feature.

22. The conduit of claim 1, further comprising a second elongate body of a third dielectric material; the second elongate body extending continuously along a longitudinal axis between a first terminus and a second terminus, where at each point along the longitudinal axis an orthogonal cross-section of the second elongate body has a first dimension along a major axis of the cross-section, where the major axis is defined as the largest dimension of the cross-section, and a second dimension along a minor axis of the cross-section, where the minor axis is defined as a widest dimension of the cross-section that is at a right angle to the major axis;
the second elongate body having a surface, where at least a quarter of the area of the surface is covered by a second reflective cladding that is a reflective material or a combination of reflective materials configured to reflect a second electromagnetic EHF signal when propagated along the length of the second elongate body;
where for each cross-section of the second elongate body, the first dimension is greater than a known wavelength of the second electromagnetic EHF signal and the second dimension is less than the known wavelength of the second electromagnetic EHF signal; and
where the second elongate body extends at least partially along and adjacent to the first elongate body, and is separated from the first elongate body by at least one of the first or second reflective cladding.

23. The conduit of claim 22, wherein the first and second elongate bodies have substantially equal dimensions along their major and minor axes.

24. The conduit of claim 22, wherein the combination of the first and second elongate bodies is enclosed by the first and second reflective cladding materials.

25. A conduit for propagation of electromagnetic EHF signals, comprising:
a plurality of elongate bodies of dielectric material, each elongate body configured for propagation of an independent electromagnetic EHF signal, and the dielectric material of each elongate body being the same or different;
where each elongate body extends continuously along a longitudinal axis between a first terminus and a second terminus, where at each point along the longitudinal axis an orthogonal cross-section of each elongate body has a first dimension along a major axis of the cross-section, where the major axis is defined as the largest dimension of the cross-section, and a second dimension along a minor axis of the cross-section, where the minor axis is defined as a widest dimension of the cross-section that is at a right angle to the major axis;
where for each cross-section of each elongate body, the first dimension is greater than a known wavelength of the electromagnetic EHF signal to be propagated along that elongate body, and the second dimension is less than the known wavelength of the electromagnetic EHF signal to be propagated along that elongate body; and
where for at least a portion of each of the plural elongate bodies, the plural elongate bodies extends in combination and adjacent one another, where each elongate body is separated from each adjacent elongate body by a first reflective cladding that is a reflective material or combination of reflective materials configured to reflect the electromagnetic EHF signals propagated along the lengths of the elongate bodies.

26. The conduit of claim 25, where the combination of adjacent elongate bodies is enclosed by the first or a second reflective cladding material.

27. The conduit of claim 26, wherein the first and second reflective claddings independently include a conductive material, a dissipative material, or an additional dielectric material.

28. The conduit of claim 25, wherein each cross-section along the longitudinal axis of each elongate body defines a rectangle, such that each elongate body defines an elongate cuboid of dielectric material.

29. The conduit of claim 28, wherein the surface of each elongate body includes a first lateral surface and a second lateral surface spaced from the first lateral surface, a distance separating the first and second lateral surfaces defining the width of that elongate body along the major axis; and a first major surface and a second major surface spaced from the first major surface, a distance separating the first and second major surfaces defining the depth of that elongate body along the minor axis.

30. The conduit of claim 29, the conduit including two elongate bodies extending in combination and adjacent one another such that one of the lateral surfaces of a first elongate body is separated from one of the lateral surfaces of a second elongate body by the first reflective cladding.

31. The conduit of claim 29, the conduit including two elongate bodies extending in combination and adjacent one another such that one of the major surfaces of a first elongate body is separated from one of the major surfaces of a second elongate body by the first reflective cladding.

32. The conduit of claim 29, the conduit including four elongate bodies extending in combination and adjacent one another in a two-by-two array, such that each elongate body is separated from each other elongate body by the first reflective cladding.

33. A method of propagating an electromagnetic EHF signal along a conduit according to claim 1, comprising:
transmitting an electromagnetic EHF signal using an electromagnetic EHF transmitter;
disposing the first terminus of the elongate body of the conduit adjacent the EHF transmitter so that at least a portion of the transmitted electromagnetic EHF signal is directed into the elongate body via the first terminus; and
propagating the directed portion of the electromagnetic EHF signal along the elongate body to the second terminus of the elongate body.

34. The method of claim 33, further comprising disposing the second terminus of the elongate body of the conduit adjacent an EHF receiver configured to receive EHF radiation;
emitting the propagated electromagnetic EHF signal from the second terminus of the elongate body of the conduit; and
receiving the emitted electromagnetic EHF signal by the EHF receiver.

35. The method of claim 34, wherein the EHF transmitter corresponds to a first EHF transducer, and the EHF receiver corresponds to a second EHF transducer, further comprising:
transmitting a second electromagnetic EHF signal using the second EHF transducer;
receiving at least a portion of the transmitted second electromagnetic EHF signal into the elongate body via the second terminus; and
propagating the received portion of the second electromagnetic EHF signal along the elongate body to the first terminus of the elongate body;
emitting the propagated second electromagnetic EHF signal from the first terminus of the elongate body of the conduit; and
receiving the emitted second electromagnetic EHF signal by the first EHF transducer.
